(19) United States
(12) Patent Application Publication
(10) Pub. No.: US 2024/0351784 A1
(43) Pub. Date: Oct. 24, 2024

(54) A GRIPPER ASSEMBLY

(71) Applicant: Autostore Technology AS, Nedre Vats (NO)

(72) Inventor: Kjetil Gilje, Sandeid (NO)

(73) Assignee: Autostore Technology AS, Nedre Vats (NO)

(21) Appl. No.: 18/686,732

(22) PCT Filed: Aug. 25, 2022
(86) PCT No.: PCT/EP2022/073648

§ 371 Date: Feb. 26, 2024

(30) Foreign Application Priority Data
Aug. 27, 2021 (NO) 20211029

(51) Int. Cl. B65G 1/04

(52) U.S. Cl. CPC B65G 1/0464

(57) ABSTRACT

A vertically displaceable gripper assembly is suspended from a remotely operated vehicle operating on top of upright members of an automated storage and retrieval system. The gripper assembly engages with a goods holder positioned in a storage column defined by a set of upright members. The goods holder has an open side. The gripper assembly includes a detector for determining whether goods placed in the goods holder project out of the open side of the goods holder.

The present invention relates to a vertically displaceable gripper assembly suspended from a remotely operated vehicle operating on top of upright members of an automated storage and retrieval system, said gripper assembly for engaging with a goods holder positioned in a storage column of said system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a, 404a for vertical transportation of storage containers 106, e.g. raising a storage container 106 from, and lowering a storage container 106 into, a storage column 105. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference number. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

WO2019/206482A1 discloses a container-handling vehicle for picking up storage containers from a three-dimensional grid of a storage system and comprising a vehicle body and at least one lifting device for lifting a storage container from the grid. The lifting device comprises a lifting band drive assembly, a lifting frame and a plurality of lifting bands.

With reference to the lifting device and its lifting frame of WO2019/206482A1, said lifting frame part may encounter various problems when attempting to connect to the storage bin. By way of example, the bin may be overfilled, preventing the physical connection of the lifting frame part and the bin to take place. This could be caused by flaps of a cardboard box positioned in the storage bin suddenly popping up from the bin, or by a many fold increase in size of vacuum-packaged goods upon perforation. In a closely related situation, bin recess, actual location where the lifting frame part gets into physical contact with the bin, may be blocked by bin content. Typically, overfilled bins and blocked bin recesses generate the same error code at the operator's, thus making troubleshooting efforts more difficult. In this context, a set of dedicated sensors is normally employed to establish state of the lifting frame part relative to the storage bin. However, this sensor system doesn't take into account disturbances of the above kind.

In view of the above it is desirable to provide a solution that solves or at least mitigates one or more of the aforementioned problems belonging to the prior art.

### SUMMARY OF THE INVENTION

The present invention is set forth and characterized in the independent claims, while the dependent claims describe other characteristics of the invention.

First aspect of the invention relates to a vertically displaceable gripper assembly suspended from a remotely operated vehicle operating on top of upright members of an automated storage and retrieval system, said gripper assembly for engaging with a goods holder positioned in a storage column defined by a set of said upright members, said goods holder having an open side, said gripper assembly comprising a detector for determining whether goods placed in the goods holder project out of the open side of said goods holder.

By providing the gripper assembly with the detector for determining whether goods placed in the goods holder project out of the goods holder, a possible disturbance associated with the content of the goods holder may be detected well ahead of the gripper assembly being brought in contact with the goods holder. As a consequence, engaging of the gripper assembly may be timely interrupted and potential damage, caused by the undesirable contact of the gripper assembly and the goods holder, may be avoided.

Moreover, the system doesn't need to generate an error code as the movement of the gripper assembly is timely stopped. In consequence, the troubleshooting process is rendered unnecessary.

In addition, the above-mentioned set of sensors for establishing state of the gripper assembly relative to the goods holder may be dispensed with, thus simplifying the overall design as well as reducing the number of parts of the gripper assembly.

Second aspect of the invention relates to a method for operating a vertically displaceable gripper assembly suspended from a remotely operated vehicle of an automated storage and retrieval system, the gripper assembly for engaging with a goods holder positioned in a storage column of said system, said goods holder having an open side. For the sake of brevity, advantages discussed above in connection with the gripper assembly may even be associated with the method for operating said gripper assembly and are not further discussed.

For the purposes of this application, the term “container handling vehicle” used in “Background and Prior Art”-section of the application and the term “remotely operated vehicle” used in “Detailed Description of the Invention”-section both define an autonomous wheeled vehicle operating on a rail system arranged across the top of the framework structure being part of an automated storage and retrieval system.

Analogously, the terms “storage container” and “storage bin” used in “Background and Prior Art”-section of the application and the term “goods holder” used in “Detailed Description of the Invention”-section both define a receptacle for storing items. In this context, the goods holder can be a bin, a tote, a pallet, a tray or similar. Different types of goods holders may be used in the same automated storage and retrieval system.

Moreover, the term “lifting frame part” used in “Background and Prior Art”-section of the application and the term “gripper assembly” used in “Detailed Description of the Invention”-section both define a device for vertical transportation of storage containers, e.g. raising a storage container from, and lowering a storage container into, a storage column.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view, seen from below, of a prior art container handling vehicle having an internally arranged cavity for carrying storage containers therein.

FIG. 4a is a perspective view showing a gripper assembly of the present invention in engagement with a goods holder.

FIG. 4b is a perspective view showing a gripper assembly of FIG. 4a when disengaged from a goods holder.

FIG. 5a shows a gripper assembly of the present invention seen slantingly from above.

FIG. 5b is a cross-sectional view of the gripper assembly of FIG. 5a.

FIG. 5c shows a gripper assembly of the present invention seen slantingly from below.

FIG. 6 is a top view of a goods holder prior to engagement with a gripper assembly of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

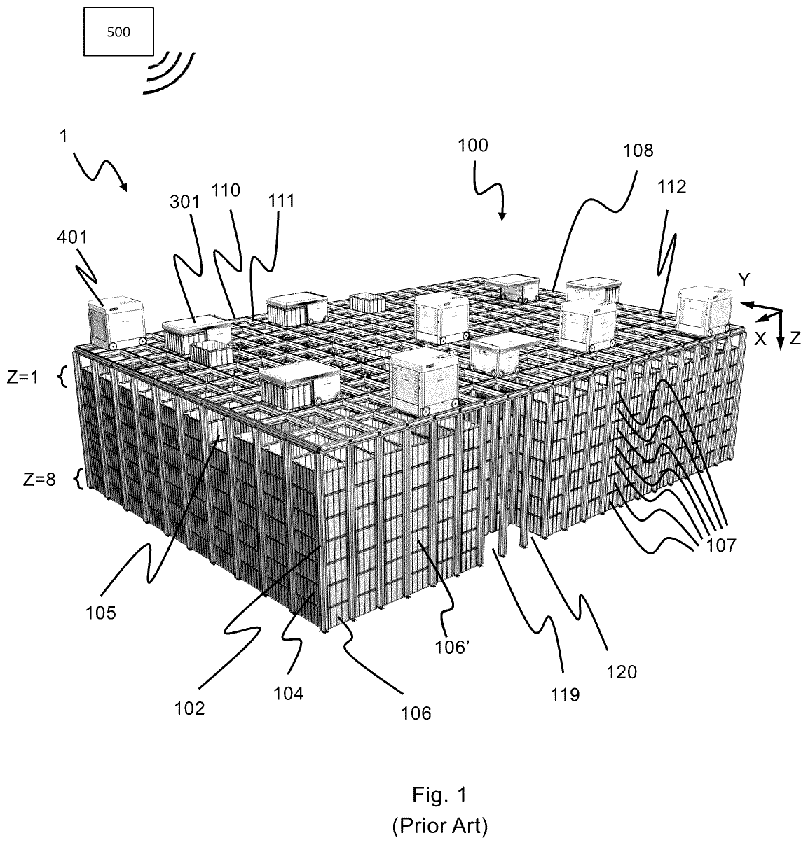

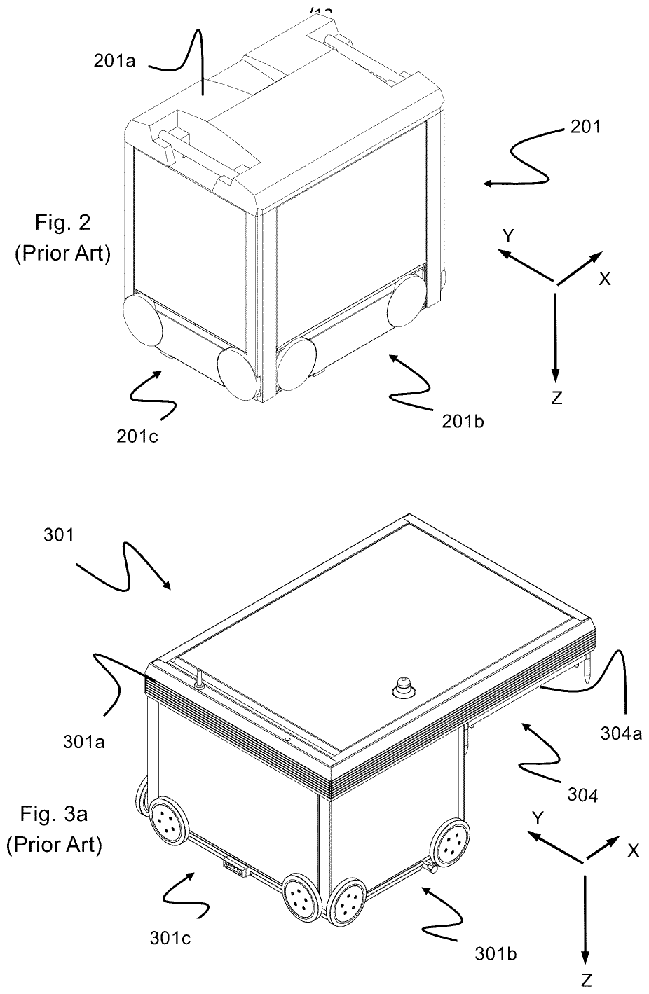

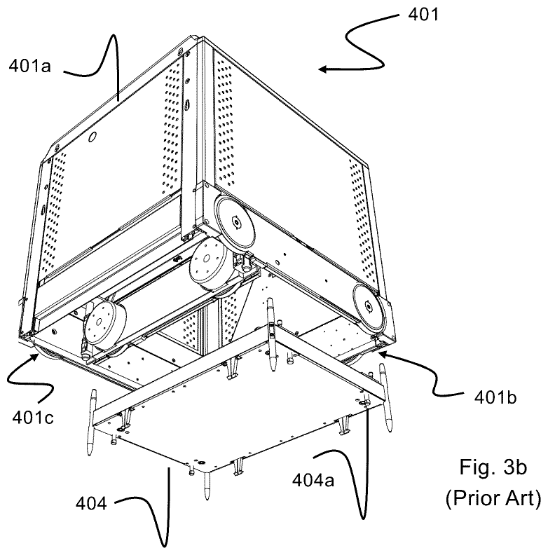

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

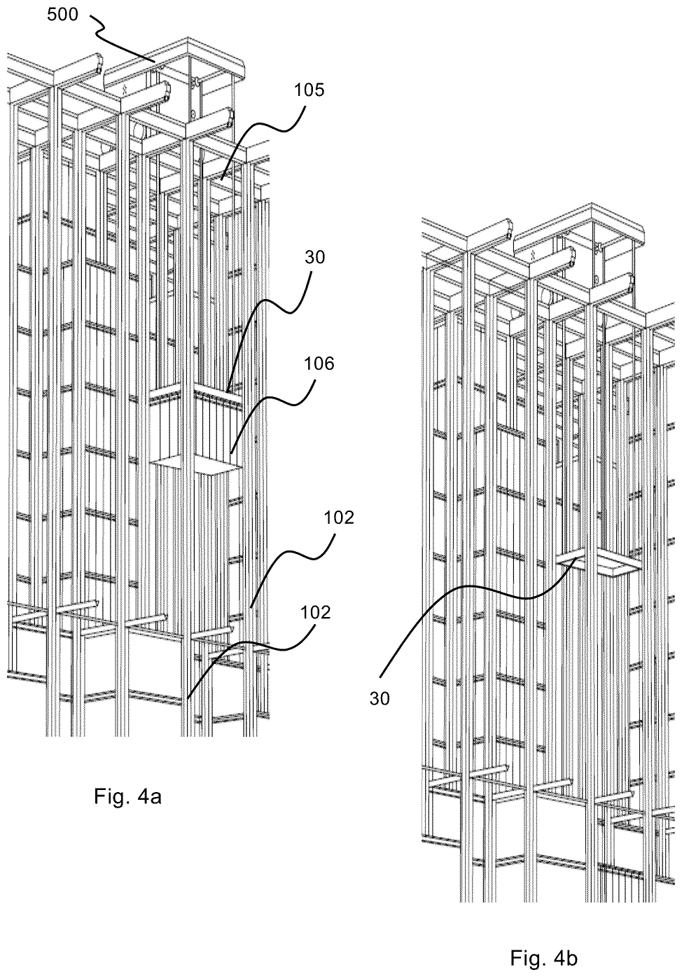

Various aspects of the present invention will now be discussed in more detail with reference to FIGS. 4a-6.

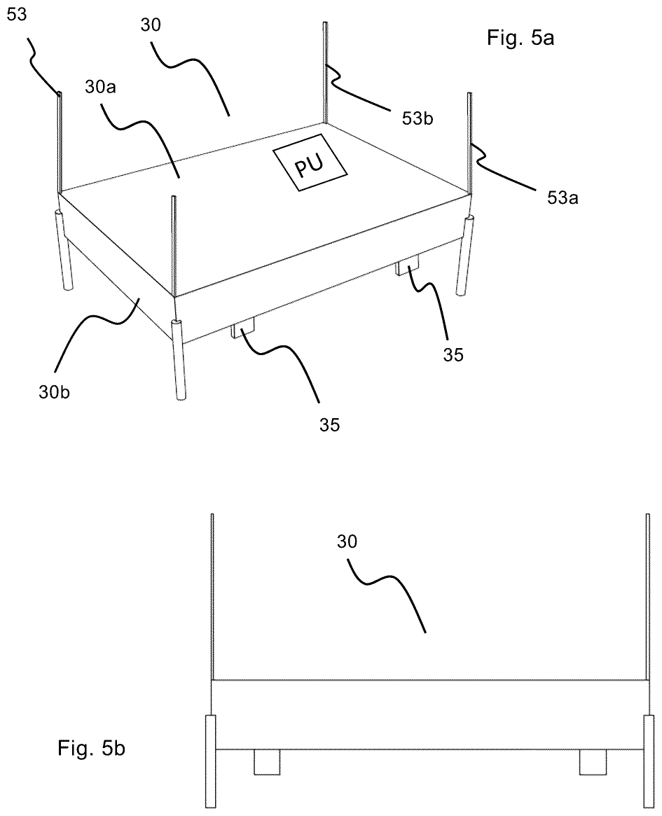

FIG. 4a is a perspective view showing a gripper assembly of the present invention in engagement with a goods holder. More specifically, a vertically displaceable gripper assembly 30 is suspended from a remotely operated vehicle 500 operating on top of upright members 102 of an automated storage and retrieval system (discussed in connection with FIG. 1). In FIG. 4a, the gripper assembly 30 is in engagement with a goods holder 106 positioned in a storage column 105 defined by a set of said upright members 102. Functionally, the gripper assembly 30 is a part of the shown remotely operated vehicle 500. The gripper assembly 30 is suspended from the remotely operated vehicle 500 by means of lifting bands discussed in greater detail in connection with FIG. 5a.

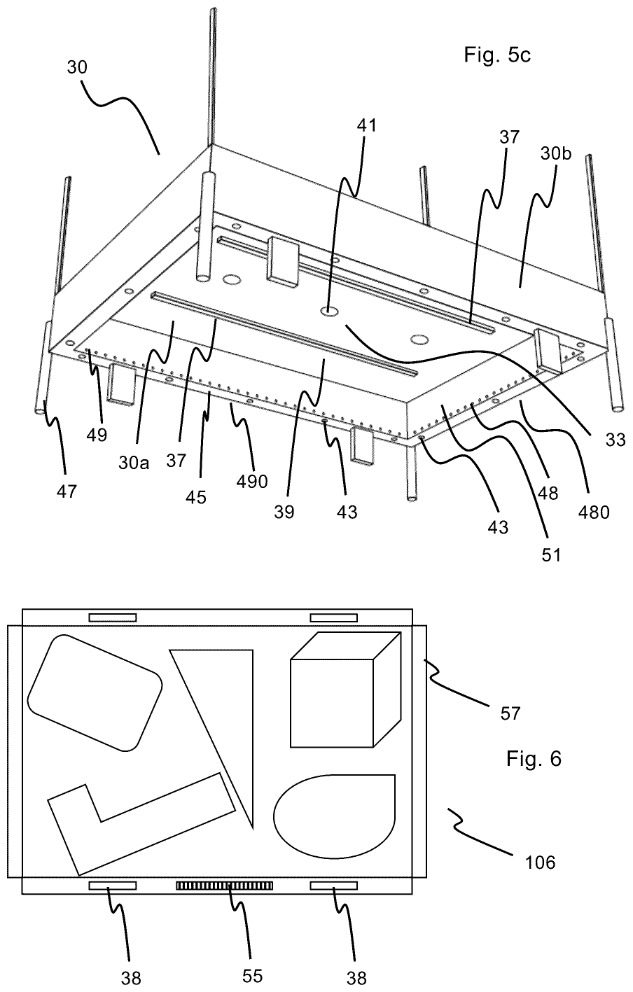

FIG. 4b is a perspective view showing a gripper assembly 30 of FIG. 4a when disengaged from a goods holder (not shown in FIG. 4b) positioned further below in the storage column. For the sake of brevity, parts discussed in conjunction with FIG. 4a are not further discussed. As is well known, in a standard automated storage and retrieval system, goods holders have an open proximal side. Here, term “proximal” is to be construed as being nearest the gripper assembly 30. Such a goods holder is shown in FIG. 6. It is in scenario shown in FIG. 4b (gripper assembly 30 hovering above the loaded goods holder), that it is desirable to know whether goods placed in the goods holder project out of the open side of the goods holder. To that purpose, the gripper assembly 30 comprises a detector discussed in connection with FIGS. 5a-5c.

By providing the gripper assembly 30 with the detector for determining whether goods placed in the goods holder project out of the goods holder, a possible disturbance associated with the content of the goods holder may be detected well ahead of the gripper assembly being brought in contact with the goods holder. As a consequence, engaging of the gripper assembly 30 may be timely interrupted and potential damage, caused by the undesirable contact of the gripper assembly and the goods holder, may be avoided. Moreover, there is no need to generate an error code as the movement of the gripper assembly 30 is timely stopped. In consequence, the troubleshooting process is rendered unnecessary.

FIG. 5a shows a gripper assembly 30 of the present invention seen slantingly from above. The gripper assembly 30 comprises a quadrangularly shaped base plate 30a and a circumferentially extending rim 30b arranged at a periphery of the base plate 30a, said rim 30b being perpendicular to the base plate 30a. Furthermore, the gripper assembly 30 comprises a pair of gripper elements 35 on each long side. These gripper elements 35 are for engagement with corresponding recesses arranged in a body of the goods holder discussed in conjunction with FIG. 6. In certain embodiments, gripper elements 35 may have adjustable length.

The gripper assembly 30 is suspended from a remotely operated vehicle (not shown in FIG. 5a) by means of lifting bands 53. At least one lifting band 53a is employed to supply energy to the gripper assembly 30. At least one further lifting band 53b is employed for communication between the remotely operated vehicle and the gripper assembly 30. By way of example, said communication takes place over a wire-based, high-speed data bus. In a preferred embodiment, all data generated by means of the gripper assembly 30 is processed in a processing unit PU located at the gripper assembly 30. Hereby, decision latency and/or airtime (noise) may be reduced and the overall system performance may be improved. In an alternative embodiment, data is processed in the processing unit of the remotely operated vehicle.

In one embodiment (not shown), the gripper assembly 30 comprises a tilt sensor in the shape of the gyroscope. Tilt angle of the gripper assembly 30 could also be determined indirectly, for instance by deriving necessary information from the tension force acting on each of the lifting bands 53.

FIG. 5b is a cross-sectional view of the gripper assembly 30 of FIG. 5a.

FIG. 5c shows a gripper assembly 30 of the present invention seen slantingly from below. In addition to parts already discussed in connection with FIG. 5a, the gripper assembly 30 comprises a light source 37 for illuminating the goods holder (shown in FIG. 6). The light source 37 is provided at a lower surface 39 of the base plate 30a. In the shown embodiment, the light source 37 is a pair of arrays comprising light-emitting diodes (LEDs).

In this embodiment, a detector 33 for determining whether goods placed in the goods holder project out of the open side of said goods holder 106) comprises three image recording devices 41 provided centrally at the lower surface 39 of the base plate 30a. The image taken by the image recording device 41 may be forwarded to the operator. The operator hereby gains valuable information about state of the goods holder and may take measures necessary to solve the problem at hand, typically without having to carry out an in-situ inspection of the compromised goods holder.

In one embodiment, the image recording device 41 consists of a single stereo camera. Such a stereo camera is also able to determine distance between the gripper assembly 30 and goods placed in the goods holder. The stereo camera may have zoom-functionality and/or be directional.

Still with reference to FIG. 5c, the detector comprises a plurality of proximity sensors 43 emitting signals in a substantially vertical direction, i.e. directly towards the goods holder. The proximity sensors 43 are provided at a lower surface 45 of the rim 30b. In another embodiment, a proximity sensor may be integrated into a vertically extending guide pin 47 provided in a corner of the base plate 30a.

Moreover, the detector of the gripper assembly 30 further comprises senders 48 emitting a beam of light in a substantially horizontal direction and oppositely arranged receivers 49. Emitted light is either in visible or in infrared spectrum. Still with reference to FIG. 5c, a first array of senders 480 on the short side of the gripper assembly is visible, whereas the corresponding array of oppositely arranged receivers cannot be seen. A second array of receivers 490 is visible on the long side of the gripper assembly. The first and second arrays 480, 490 are provided at an inner surface 51 of the rim 30b such that they face interior of the gripper assembly 30.

FIG. 6 is a top view of a loaded goods holder 106 prior to engagement with a gripper assembly of the present invention. Shown goods holder 106 has an open proximal side. Here, term “proximal” is to be construed as being nearest the gripper assembly, when the goods holder is in a storage column of FIG. 4a. The particular goods holder 106 may be identified by means of a bar code 55 arranged on an edge 57 delimiting said open side of the goods holder 106. In such a system comprising identifiable goods holders, the gripper assembly would comprise a device (not shown) for identifying a goods holder 106 based on the information provided in the bar code 55. Such a device is normally a part of the detector discussed in conjunction with FIGS. 5a-5c. Previously discussed recesses 38, for receiving gripper elements of FIGS. 5a-5c, are arranged in a body of the goods holder 106.

Ability to identify particular goods holders is useful in situations where position of the remotely operated vehicle needs to be recovered. This can be done as a side process performed alongside main process of determining whether goods are projecting from the open side of the goods holder 106. In a related context, if the remotely operated vehicle fails to pick up the correct goods holder, it is useful to backtrack latest vehicle activity by letting the remotely operated vehicle inspect bar codes of relevant goods holders stored in the system of FIG. 1, without having to bring these goods holders to a port for manual inspection.

In the preceding description, various aspects of the gripper assembly and the remotely operated vehicle according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Storage and retrieval system
30 Gripper assembly
30a Base plate
30b Rim
33 Detector
35 Gripper element
37 Light source
38 Recess
39 Lower surface of the base plate
41 Image recording device
43 Proximity sensor
45 Lower surface of the rim
47 Guide pin
48 Sender
49 Receiver
51 Inner surface of the rim
53 Lifting bands
53 Lifting band for supplying energy
53b Lifting band for communication
55 Bar code
57 Edge of the goods holder
102 Upright members of framework structure
104 Storage grid
105 Storage column
106 Storage container; Goods holder
106′ Particular position of storage container
107 Stack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
401 Container handling vehicle belonging to prior art
401a Vehicle body of the container handling vehicle 401
401b Drive means in first direction (X)
401c Drive means in second direction (Y)
480 Array of senders
490 Array of receivers
500 Remotely operated vehicle
X First direction
Y Second direction
z Third direction
PU Processing unit

1. A vertically displaceable gripper assembly suspended from a remotely operated vehicle operating on top of upright members of an automated storage and retrieval system, said gripper assembly for engaging with a goods holder positioned in a storage column defined by a set of said upright members, said goods holder having an open side, said gripper assembly comprising a detector for determining whether goods placed in the goods holder project out of the open side of said goods holder.

2. A gripper assembly of claim 1, the gripper assembly further comprising a gripper element for engagement with a recess arranged in a body of the goods holder.

3. A gripper assembly of claim 2, wherein said gripper element has adjustable length.

4. A gripper assembly of claim 1, wherein the gripper assembly comprises a quadrangularly shaped base plate and a circumferentially extending rim arranged at a periphery of the base plate, said rim being perpendicular to the base plate.

5. A gripper assembly of claim 4, the gripper assembly further comprising a light source for illuminating the goods holder, said light source being provided at a lower surface of the base plate.

6. A gripper assembly of claim 4, wherein said detector comprises at least one image recording device.

7. A gripper assembly of claim 6, wherein said image recording device is a stereo camera provided centrally at the lower surface of the base plate.

8. A gripper assembly of claim 1, wherein said detector further comprises a device for determining distance between the gripper assembly and goods placed in the goods holder.

9. A gripper assembly of claim 4, wherein said detector comprises at least one proximity sensor emitting signals in a substantially vertical direction.

10. A gripper assembly of claim 9, wherein said at least one proximity sensor is provided at a lower surface of the rim.

11. A gripper assembly of claim 9, wherein said at least one proximity sensor is integrated into a vertically extending guide pin provided in one corner of the rim.

12. A gripper assembly of claim 1, the gripper assembly further comprising a tilt sensor.

13. A gripper assembly of claim 1, the gripper assembly further comprising at least one sender emitting a beam of light and at least one oppositely arranged receiver, wherein said sender emits in a substantially horizontal direction.

14. A gripper assembly of claim 13, wherein said light is either in visible or in infrared spectrum.

15. A gripper assembly of claim 13, wherein said gripper assembly comprises a first array of senders and a second array of oppositely arranged receivers.

16. A gripper assembly of claim 15, wherein said first and second arrays are provided at an inner surface of the rim such that they face interior of the gripper assembly.

17. A gripper assembly of claim 1, wherein the gripper assembly is suspended from the remotely operated vehicle by means of lifting bands, wherein at least one lifting band is employed to supply energy to the gripper assembly and at least one further lifting band is employed for communication between the remotely operated vehicle and the gripper assembly.

18. A gripper assembly of claim 17, wherein communication between the remotely operated vehicle and the gripper assembly takes place over a wire-based, high-speed data bus.

19. A gripper assembly of claim 1, wherein all data generated by means of the gripper assembly is processed in a processing unit located at the gripper assembly.

20. A gripper assembly of claim 1, wherein the gripper assembly comprises a device for identifying a goods holder based on the information provided on the goods holder.

21. A gripper assembly of claim 20, wherein said device for identifying a goods holder is a part of said detector for determining whether goods placed in the goods holder project out of the open side of said goods holder and the information provided on the goods holder is a bar code arranged on an edge delimiting said open side of the goods holder.

22. A remotely operated vehicle comprising a gripper assembly of claim 1, said gripper assembly being suspended from the remotely operated vehicle by means of lifting bands.

23. A method for operating a vertically displaceable gripper assembly suspended from a remotely operated vehicle of an automated storage and retrieval system, the gripper assembly for engaging with a goods holder positioned in a storage column of said system, said goods holder having an open side, the method comprising:
determining whether goods placed in the goods holder project out of the open side of said goods holder.

24. A method of claim 23, further comprising:
if determined that goods placed in the goods holder project out of the open side of the goods holder, discontinuing engaging of the gripper assembly and the goods holder.

25. A method of claim 23, further comprising:
if determined that goods placed in the goods holder project out of the open side of the goods holder, recording an image of the open side of the goods holder.

26. A method of claim 23, further comprising:
determining distance between the gripper assembly and goods placed in the goods holder.

27. A method of claim 23, further comprising:
emitting, by means of a proximity sensor, signals in a substantially vertical direction.

28. A method of claim 23, further comprising:
emitting, by means of a sender, a beam of light in a substantially horizontal direction, and
if said beam of light is not received by a means of a receiver, discontinuing engaging of the gripper assembly with the goods holder.

29. A method of claim 23, further comprising:
identifying a goods holder based on the information provided on the goods holder.
